(19) United States
(12) Patent Application Publication
(10) Pub. No.: US 2010/0155297 A1
(43) Pub. Date: Jun. 24, 2010

(54) REMOVAL OF NITROGEN COMPOUNDS

(75) Inventors: Peter John Herbert Carnell, Cleveland (GB); Matthew John Cousins, County Durham (GB); Lucy Jane Challis, County Durham (GB)

Correspondence Address: RATNERPRESTIA, P.O. BOX 980, VALLEY FORGE, PA, 19482, US

(73) Assignee: JOHNSON MATTHEY PUBLIC LIMITED COMPANY, London (GB)

(21) Appl. No.: 11/993,292

(22) PCT Filed: Jun. 7, 2006
(86) PCT No.: PCT/GB06/50141

§ 371 Date: Dec. 20, 2007

(30) Foreign Application Priority Data
Jun. 20, 2005 (GB) 0512459.9

(51) Int. Cl. C10G 25/00

(52) U.S. Cl. 208/91; 208/254 R

(57) ABSTRACT

A process for the removal of one or more nitrogen compounds, e.g. basic nitrogen compound from a fluid stream is described in which the fluid is contacted with a functionalized polymer fibre material having functional groups capable of reacting with the nitrogen compounds.

The present invention concerns a process for the removal or the reduction of the amount of nitrogen-containing compounds in a fluid stream.

The majority of nitrogen compounds that occur in petroleum are regarded as undesirable due to the problems that they pose in refining. Nitrogen compounds can reduce the efficiency of hydrotreating catalysts and so their elimination is critical in order to reach the low sulphur levels that future legislation dictates. In addition, a number of nitrogen compounds are toxic; several of the aza heterocycles and aromatic primary amines are known, or suspected to be carcinogens. Complete removal of these nitrogen compounds by hydrodenitrification (HDN) requires severe reaction conditions at escalated cost (high energy and hydrogen consumption). In addition, these harsh conditions may result in the saturation of desirable olefins and aromatic compounds and therefore lowered octane numbers in the product hydrocarbon. If milder HDN conditions are used, then aromatic nitrogen compounds are usually unconverted, e.g. pyridine and quinoline.

Hydrocarbon feedstocks, such as naphtha, contain a variety of impurities including organic sulphur and nitrogen compounds. In order to decrease these impurities to acceptable levels, it is commonplace to subject the feedstock to a hydrotreating step wherein the feedstock, in admixture with hydrogen, is passed at an elevated temperature over a bed of a suitable catalyst, such as a supported, sulphided, cobalt or nickel/molybdenum composition. The sulphur compounds are converted to hydrogen sulphide and the nitrogen compounds to ammonia. The mixture is then cooled and passed to a stripping column where the treated feedstock is separated as a liquid phase and the light components, including hydrogen, hydrogen sulphide and ammonia, are separated as a gaseous stream. The resultant treated feedstock stream typically has organic sulphur and organic nitrogen contents each in the range 0.2 to 0.5 ppm by weight. The treated hydrocarbon feedstock is then often subjected to catalytic reforming to increase the aromatics content of the hydrocarbon stream. The catalysts employed for catalytic reforming are often noble metals, such as platinum and/or rhenium on a suitable support. Generally the catalytic reforming catalyst is used in the form of a chloride and indeed it is often desirable to add chlorine compounds to maintain the reforming catalyst in the active state. The catalytic reforming reaction produces hydrogen and any residual nitrogen compounds in the feed will tend to be hydrogenated by the reforming catalyst to give ammonia, and likewise hydrogen chloride will be formed by reaction of the hydrogen with the catalyst. The hydrogen chloride and ammonia will tend to combine to form ammonium chloride and it has been found that this can lead to fouling and blockages in the catalytic reforming unit stabiliser section and hydrogen make-gas systems.

Another problem that may be caused by the presence of nitrogen compounds is the formation of nitrogen oxides (NOx) in gas streams, e.g. in FCC streams.

The presence of nitrogen compounds in non-hydrocarbon process streams may also cause problems such as unpleasant odours or taint.

It is therefore an object of the invention to provide a process for the removal of nitrogen compounds from fluid streams.

U.S. Pat. No. 5,942,650 describes the removal of nitrogen compounds from an aromatic stream by contact with a selective adsorbent having an average pore size less than about 5.5 Angstroms to produce a treated feed stream essentially free of the nitrogen compound. The selective adsorbent is a molecular sieve selected from the group consisting of pore closed zeolite 4A, zeolite 4A, zeolite 5A, silicalite, F-silicalite, ZSM-5 and mixtures thereof.

The amount of residual nitrogen in the hydrotreated feedstock can also be decreased by increasing the temperature of the hydrotreating stage. However such increased temperature operation is economically unattractive.

Accordingly the present invention provides a process for the removal of one or more nitrogen compounds from a fluid stream by contacting said fluid with a functionalised polymer fibre material having functional groups capable of reacting with said nitrogen compounds.

In the present invention, the nitrogen compounds are preferably basic nitrogen compounds, which may be ammonia and/or organic nitrogen compounds such as amines or cyclic compounds such as pyridines, quinolines etc. Organic nitrogen compounds that may be removed by the process of the present invention include, but are not limited to the following;

(i) Basic nitrogen compounds selected from;

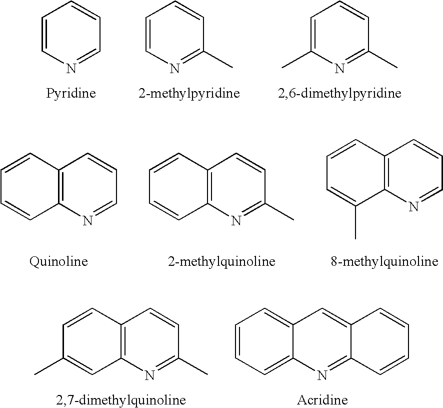

(ii) Non-basic nitrogen compounds selected from;

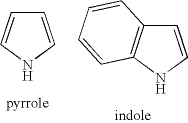

In a preferred form, the present invention provides a process for the removal of basic nitrogen compounds from a fluid stream by contacting said stream with a functionalised polymer fibre capable of binding the basic nitrogen compounds. Basic nitrogen compounds that may be removed by the process of the present invention include ammonia and/or in particular one or more basic organic nitrogen compounds, especially aromatic heterocyclic nitrogen compounds such as substituted or unsubstituted pyridines, quinolines or acridines.

Preferably, the polymer fibre comprises a polymer selected from the group consisting of polyolefins, polyolefin-styrene copolymers, polyacrylates, fluorinated polyethylene, cellulose and viscose. Polyolefin-styrene copolymers are preferred as these are readily synthesised with suitable functional groups on the styrene rings.

Suitable polyolefins are those formed from units of α-olefins, the units having the formula —CH₂—CHR—, where R is H or (CH₂)ₙCH₃ and n is in the range of 0 to 20. Particularly suitable polyolefins are those which are homo- or co-polymers of ethylene and propylene. In the case of fluorinated polyethylenes, those formed from units of the general formula —CF₂—CX₂—, where X is H or F are suitable. For example, polyvinylidene fluoride and polytetrafluoroethylene are particularly preferred.

The functional groups can be introduced in various ways including radiation grafting, chemical grafting, chemical modification of pre-formed fibres or further chemical modification of grafted fibres, formation of interpenetrating networks etc. Preferably the functional groups are introduced by radiation grafting.

Radiation grafting is a known procedure, and involves the irradiation of a polymer in a suitable form, for example, film, fibre, pellets, hollow fibre, membrane or non-woven fabric, to introduce reactive sites (free radicals) into the polymer chain. These free radicals can either combine to give cross-links, as is the case for polyethylene, or cause chain scission as is the case for polypropylene. Alternatively, the free radicals can be utilised to initiate graft copolymerisation under specific conditions. Three different methods of radiation grafting have been developed; 1) direct radiation grafting of a vinyl monomer onto a polymer (mutual grafting); 2) grafting on radiation-peroxidized polymers (peroxide grafting); and 3) grafting initiated by trapped radicals (pre-irradiation grafting). Pre-irradiation grafting is mostly preferred since this method produces only small amounts of homopolymer in comparison to mutual grafting.

Preferably, the functionalised polymer fibre comprises at least one functional group selected from; carboxylic acid, sulphonic acid, pyridinium, isothiouronium, phosphonium, amine, thiol or the like, and grafted vinyl monomers such as acrylic acid, methacrylic acid, acrylates, methacrylates, styrene, substituted styrenes such as α-methyl styrene, vinyl benzyl derivatives such as vinyl benzyl chloride, vinyl benzyl boronic acid and vinyl benzyl aldehyde, vinyl acetate, vinyl pyridine, and vinyl sulphonic acid. Preferably the functionalised polymer fibre contains cationic groups, particularly sulphonic acid groups. For removal of basic nitrogen compounds, such as pyridines and quinolines from hydrocarbon liquids, it is preferred to use a strongly acidic functionalised polymer fibre. A functionalised polymer fibre having at least 1.0 mmol per gram of functional groups, e.g. sulphonic acid groups, more preferably from 2.0-4.5 mmol per gram, especially 2.0-3.0 mmol per gram is preferred.

Preferably, the polymer is substantially non-porous. The lack of porosity provides the polymers with sufficient mechanical strength to withstand use in stirred reactors without creating fines. Difficulties associated with further processing of the polymers by for example, elution are also mitigated.

In the present invention, the functionalised polymer fibres may be used without further processing and be of any length however, they have the very substantial advantage over polymer beads in that they may be converted, using conventional technology, into a great variety of forms. Thus, fibres may be spun, woven, carded, needle-punched, felted or otherwise converted into threads, ropes, nets, tows or woven or non-woven fabrics of any desired form or structure. Fibres can easily be stirred in a liquid medium, and filtered off or otherwise separated. In processes wherein a stream of said fluid flows through a bed of said functionalised polymer fibre it is desirable to convert the fibres into threads, ropes, nets, tows or woven or non-woven fabrics in order to reduce the pressure drop through the bed. If desired, fibres of different characteristics can readily be combined in threads or fabrics, in order to optimise properties for a particular feedstock medium. In an embodiment, fibres may be combined with inorganic fibres such as silica, alumina or carbon fibres in order to provide increased mechanical strength or combined with non-functionalised polymer fibres. This may be of use when the fibres are used in fixed bed processes or stirred processes which involve high degrees of agitation or high turbulence.

An advantage of the use of the functionalised polymer fibres of the invention compared with the use of conventional resin beads is that the fibres show little tendency to swell in non-aqueous systems, whereas swelling of a bed of resin beads during use places restrictions on the design of the vessels in which they are used.

For use in the process of the invention, the fibres are preferably in the form of a non-woven mass or mat so that the surface area of the fibre which is exposed to the fluid stream is as large as possible whilst maintaining as small a pressure drop as possible in order to maintain an economical flow of fluid through the mass of fibre.

The functionalised polymer fibre may contain a metal or metal ion. Preferred metals include copper, iron, manganese, cobalt and nickel and salts thereof. A metal-containing fibre may be made by treating the functionalised polymer fibre with an aqueous solution of a suitable copper, iron, manganese, cobalt or nickel salt, for example a halide, sulphate, nitrate etc.

While the functionalised polymer fibre may effect removal of the nitrogen compounds by formation of an amide linkage, or chelation with included metals, basic nitrogen compounds, particularly ammonia, amines and pyridines may be removed by metal salt-exchanged fibres through formation of a complex.

The process of the invention is effective for the removal of nitrogen-containing compounds from fluids. By fluid, we include liquid and gas streams including aqueous but particularly organic streams. The fluid must be handleable, such that it may be contacted with the functionalised polymer fibre, e.g. by flowing or pumping the fluid through or over a bed of the fibre or by stirring the fluid having the fibres suspended therein.

In a preferred process of the invention the fluid is a hydrocarbon stream. The hydrocarbon stream may be a refinery hydrocarbon stream such as naphtha (e.g. containing hydrocarbons having 5 or more carbon atoms and a final atmospheric pressure boiling point of up to 204° C.), middle distillate or atmospheric gas oil (e.g. having an atmospheric pressure boiling point range of 177° C. to 343° C.), vacuum gas oil (e.g. atmospheric pressure boiling point range 343° C. to 566° C.), or residuum (atmospheric pressure boiling point above 566° C.), or a hydrocarbon stream produced from such a feedstock by e.g. catalytic reforming. Refinery hydrocarbon steams also include carrier streams such as “cycle oil” as used in FCC processes and hydrocarbons used in solvent extraction. The hydrocarbon stream may also be a crude oil stream, particularly when the crude oil is relatively light, or a synthetic crude stream as produced from tar oil or coal extraction for example. The fluid may be a condensate such as natural gas liquid (NGL) or liquefied petroleum gas (LPG). Gaseous hydrocarbons may be treated using the process of the invention, e.g. natural gas or refined paraffins or olefins, for example.

Non-hydrocarbon fluids which may be treated using the process of the invention include solvents, such as liquid CO₂, used in extractive processes for enhanced oil recovery or decaffeination of coffee, flavour and fragrance extraction, solvent extraction of coal etc. Fluids, such as alcohols (including glycols) and ethers used in wash processes or drying processes (e.g. triethylene glycol, monoethylene glycol, Rectisol™, Purisol™ and methanol) may be treated by the inventive process. Natural oils and fats such as vegetable and fish oils may be treated by the process of the invention, optionally after further processing such as hydrogenation or transesterification e.g. to form biodiesel. The process may be used as a gas purification process, e.g. for air, particularly where recycling is needed such as in closed environments such as submarines, aeroplanes etc or for anaesthetic gases used in hospital theatres, and also in air vents.

The fluid stream may be contacted with the functionalised polymer fibre at any suitable pressure and temperature. The pressure and temperature at which the process is operated may depend on the fluid to be treated, e.g. where the fluid is handled under cryogenic conditions such as, for example, liquid CO₂ or Rectisol, then the process conditions are suitable to maintain the fluid in that state. The temperature may therefore be less than ambient, e.g. as low as −50° C. When a hydrocarbon fluid, particularly a refinery fluid is treated, the pressure is preferably in the range 1 to 100 bar abs., and the temperature in the range from ambient (e.g. 10° C.) to 250° C., preferably 20-200° C., with the fluid stream in the gaseous or liquid state. With non-aromatic hydrocarbons, such as alkanes temperatures upto 125° C. are preferred for polyolefin-styrene copolymers, whereas with aromatic hydrocarbons temperatures of upto 90° C. are preferred. When the fluid is treated by passing the fluid through a bed of the functionalised polymer fibre, then the pressure must be sufficient to move the fluid through the bed.

Depending on the fluid to be treated, the nitrogen compound content prior to contacting the fibres with the fluid may be in the range 10-2000 parts per million by volume (ppmv). The functional groups on the polymer fibres interact with the nitrogen compounds binding them to the fibres and removing them from the fluid. The fibres and fluid may be stirred together in a batch or semi-continuous mode, or the fluid may be passed continuously through a bed of fibres, which may be in woven or non-woven form until the fibres are saturated with nitrogen compound. Where the fluid is passed through such a bed the flowrate, expressed as space velocity, is preferably ≦15 hr⁻, more preferably ≦10 hr⁻¹, most preferably ≦5 hr⁻¹, especially where the nitrogen compound content of the fluid is >500 ppmv, particularly >750 ppmv.

When the fluid is a refinery hydrocarbon stream, the treatment with the functionalised polymer fibre may be effected before or after any sulphur removal step, e.g. hydrotreatment and absorption of hydrogen sulphide or mercaptans. In particular, we have found surprisingly that the presence of aromatic sulphur compounds such as thiophene, does not significantly reduce the nitrogen removal capability of acid-functionalised, particularly sulphonic acid-functionalised-polymer fibres. Treatment of the hydrocarbon stream by the method of the invention to remove nitrogen compounds before a hydrotreating step is preferred to reduce the amount of ammonia formed during hydrotreating and also makes subsequent desulphurisation easier.

The invention may be applied to hydrocarbon streams supplied to a catalytic reforming process, so that the functionalised polymer fibre can remove any ammonia present in such streams and hence the problem of the formation of ammonium chloride in the chloride-rich conditions of the catalytic reforming reaction and subsequent deposition of NH₄Cl downstream is reduced or avoided. Preferably the treatment with functionalised polymer fibre is carried out prior to the stream entering the catalytic reformer so that level of nitrogen compounds, e.g. basic nitrogen compounds, in the reformer is reduced. However, because the strongly reducing conditions of the reformer may promote the formation of ammonia from any nitrogen compounds which are present in the reformer, it may be beneficial to treat the hydrocarbon stream exiting the reformer with the functionalised polymer fibre according to the process of the invention to remove such ammonia or other nitrogen compounds, e.g. basic nitrogen compounds, present. Therefore the process of the invention may be applied either before or after a hydrocarbon processing step or both before and after if required.

Where a hydrotreating stage is employed to remove sulphur compounds from the hydrocarbon, the hydrotreating catalyst will depend on the nature of the feedstock and on the impurities to be removed. The nature and amount of the impurities will depend on the feedstock, but the feedstock may contain significant amounts of organic sulphur and nitrogen compounds and may also contain metals such as vanadium and nickel. Such metals can also be removed by a hydrotreating process. Examples of suitable hydrotreating catalysts are compositions comprising a sulphided composition containing cobalt and/or nickel plus tungsten and/or molybdenum, e.g. cobalt molybdate or tungstate or nickel molybdate or tungstate, on a support which is often alumina. The catalyst often also contains a phosphorus component. Examples of hydrotreating catalysts are described in U.S. Pat. No. 4,014,821, U.S. Pat. No. 4,392,985, U.S. Pat. No. 4,500,424, U.S. Pat. No. 4,885,594, and U.S. Pat. No. 5,246,569. The hydrotreating conditions will depend upon the nature of the hydrocarbon feedstock and the nature and amount of impurities and on the catalyst employed. Generally the hydrotreating will be effected under super-atmospheric pressure, e.g. 5 to 150 bar abs., and at a temperature in the range 300° C. to 500° C. with a hydrogen to hydrocarbon ratio of 50 to 2000 litres of hydrogen (at STP) per litre of hydrocarbon liquid (at STP). The feedstock and hydrotreating conditions are preferably such that the feedstock/hydrogen mixture is a single, i.e. gaseous, phase under the hydrotreating conditions, although a mixed phase system may alternatively be employed.

By employing a nitrogen removal step separate from hydrotreating, the hydrotreating conditions do not have to be so severe as those which would reduce or remove nitrogen compounds, especially those that are known to be harder to treat using hydrodenitrification, e.g. basic nitrogen compounds. Preferably the treatment of the feedstock with the functionalised polymer fibre is effected prior to hydrotreating and is effective to reduce the organic nitrogen content to below 0.2 ppm by weight, and preferably to below 0.1 ppm by weight, and in particular to below 0.05 ppm by weight. As a result the hydrotreating temperature may be below 350° C.

Alternatively the hydrotreating may be effected, preferably at a temperature below 350° C., prior to treatment with the functionalised polymer fibre. Again, as a result of the separate nitrogen compound removal step, the hydrotreating conditions do not have to be so severe as to give rise to mercaptan formation. Furthermore, by using the functionalised polymer fibres after steps of hydrotreating and ammonia stripping, the present invention serves to remove those organic nitrogen compounds more resistant to hydrogenation, whilst reducing the need for regeneration of the functionalised polymer fibres.

The functionalised polymer fibre may be regenerated by washing the recovered fibres with aqueous acid and optionally by treatment with a metal salt if a metal-exchanged fibre is used. Non-aqueous regeneration methods may also be used, especially where a bed of fibres is to be regenerated in-situ. Where the fluid is passed through a bed of fibres in woven or non-woven form, more than one bed of functionalised polymer fibre may be provided so that regeneration or replacement of a first bed is carried out whilst a second bed is provided for nitrogen compound, e.g. basic nitrogen compound, removal duty. More than one bed may be on-stream at any time. Many suitable arrangements of absorbent beds to optimise the process throughput and lifetime of absorbent beds are practised within industry and are known to the skilled person.

The invention will be demonstrated in the following Examples.

### EXAMPLES 1-4

A feed solution was made up containing 1000 ppm v/v of a nitrogen-containing compound (pyridine or quinoline) in a hydrocarbon liquid (n-heptane or toluene). The feed composition is given in Table 1. The feed was pumped at atmospheric pressure and room temperature (about 20-25° C.) through a glass column (3.5 cm diameter) containing a 30 ml bed (8-9 grams) of a sulphonic acid functionalised polymer fibre absorbent (Smopex™ 101, available from Johnson Matthey), having a 2.5 mmol/g loading of sulphonic acid groups on the styrene/polyethylene copolymer fibre. Smopex™ 101 is a strongly cationic exchanger having 2.5 mmol/g of functional groups. The resin contained 10% water. The fibre lengths were 0.25 mm. The bed was supported by a short plug of glass wool at the top and bottom of the bed. The exit stream was collected in a receiving vessel and not recirculated. The liquid flow through the column was maintained at a LHSV of about 10 hr⁻¹ (300 ml/hr). A sharp visible colour change was observed to move through the column as the experiment progressed and this was assumed to represent the reaction front. It was noted that the bed became compressed slightly in use and so the working bed volume was less than the starting 30 ml, resulting in slightly higher LHSV than that calculated. The concentration of the nitrogen-containing compound in the feed and exit stream was determined using gas chromatography (Varian 3600 instrument, capillary column, flame ionisation detector) by comparison with standard calibration solutions. The detection limit for pyridine is 1 ppm and for quinoline is 5 ppm. Samples of the liquid exit stream eluting from the absorbent column were taken hourly over a period of several hours. The nitrogen-containing compound in the exit stream was measured at less than 8 ppm (normally 1 ppm or undetectable). The experiment was stopped when breakthrough of the N-compound had taken place, which was judged to be when the concentration of N-compound in the exit stream was more than 100 ppm. When the colour change front had reached the end of the bed a sample was taken and this was found to be consistent with breakthrough of the N-compound. The concentration of N-compound in the exit stream remained very low until breakthrough occurred, i.e. there was no gradual rise in the concentration of N-compound observed. Table 1 shows the concentration of N-compound in the exit stream over time.

TABLE 1

| | Example 1 | Example 2 | Example 3 | Example 4 |
|---|---|---|---|---|
| | pyridine | pyridine in | quinoline in | quinoline in |
| Time | in n-heptane | toluene | n-heptane | toluene |
| (hours) | N-compound in exit stream (ppm v/v) | | | |
| 1.00 | 1 | 4 | <5 | <5 |
| 2.00 | ND | 2 | <5 | ND |
| 3.00 | ND | 8 | ND | <5 |
| 4.00 | ND | 1 | ND | <5 |
| 4.50 | — | 1 | — | — |
| 5.00 | 4 | 278 | ND | <5 |
| 5.25 | 428 | | — | — |
| 6.00 | | | <5 | <5 |
| 7.00 | | | <5 | ND |
| 7.75 | | | — | 172 |
| 8.00 | | | ND | |
| 8.25 | | | 119 | |

ND = none detected

The results indicate that the fibres may be more effective for the larger quinoline than pyridine. The nature of the hydrocarbon does not appear to make a significant difference to the ability of the functionalised polymer fibres to remove the nitrogen compounds.

### EXAMPLE 5

### Solvent Washing

Following each test of fibre absorbent in Examples 1-4, a portion (˜1 g) of the spent resin was stirred in 30 ml of an unadulterated sample of the hydrocarbon used in the feed, i.e. either fresh n-heptane or toluene to determine whether the N-compound, i.e. pyridine or quinoline, could be easily desorbed from the resin. Portions of the solvent were removed at various time intervals and analysed for pyridine or quinoline content. The results are shown in Table 2 and show that the resin fibres retain the absorbed nitrogen compounds and that they may be removed by solvent washing to only a small extent.

TABLE 2

| Reaction Time/h | | | | |
|---|---|---|---|---|
| N-compound/ | N compound extracted | | | |
| solvent | into solvent/ppm (v/v) | | | |
| combination | Example 1 | Example 2 | Example 3 | Example 4 |
| 0.5 | 19 | 24 | 16 | 78 |
| 1 | 11 | 27 | 15 | 94 |
| 2 | 11 | 20 | 21 | 77 |
| 3 | 10 | 20 | 19 | 83 |
| 4 | 9 | 24 | 18 | 81 |
| 5 | 7 | 27 | 19 | 82 |
| 24 | 9 | 27 | 17 | 74 |

### EXAMPLE 6

### Regeneration of Fibre in Acid

Following each test of fibre absorbent in Examples 1-4, a portion (˜1 g) of the spent resin was stirred in 25 ml of 50% aq. nitric acid to regenerate the resin. The resins were stirred for 1 hour, then filtered and washed with deionised water until the filtrate no longer contained acid. The resins were then dried and analysed for nitrogen content by combustion of the sample in oxygen followed by selective absorption of the combustion products and detection by thermal conductivity. The results are shown in Table 3 and show that aqueous acid washing of the recovered fibres is a feasible route to regenerate the resin fibres after they have been loaded with nitrogenous compound.

TABLE 3

| | |
|---|---|
| Spent Resin from | Nitrogen Content of Resin (% w/w) |

| Example: | Before Acid Wash | After Acid Wash |
|---|---|---|
| 1 | 2.39 | 0.25 |
| 2 | 2.23 | 0.38 |

### EXAMPLE 7

1 g of the Smopex fibre used in Examples 1-4 was stirred in 50 ml of a 1000 ppmv pyridine in heptane solution and the concentration of pyridine was monitored by sampling and analysis every two minutes. For comparison, the experiment was repeated using, separately, two different commercial ion exchange resin beads, Purolite™C-160H and Amberlyst™A15. The concentration of pyridine (ppm)in each sample, shown in Table 4, demonstrates that the absorption of the pyridine occurs faster on the functionalised fibre of the invention than on the commercial resin beads.

The increased uptake rate of the present invention compared to ion-exchange resin beads was further demonstrated by repeating Examples 1-4 using the Purolite and Amberlyst resin beads instead of the Smopex fibres. The equipment, feed, bed volume was the same, except that the flow of the feed solution through the bed was upwards. In each case, a colour change of the resin was observed as the feed flowed through the bed and the colour change advanced up the bed as the experiment progressed. Although the breakthrough times, reported as the detection of >100 ppmv of the organo-nitrogen compound in the hydrocarbon emerging from the bed, were longer than those in Examples 1-4, the concentration of the organo-nitrogen rose steadily for several hours before the 100 ppm threshold was reached and, at this point the colour change had not progressed to the exit of the bed. By contrast, when the Smopex fibre bed was used, the concentration of organo-nitrogen remained very low until breakthrough occurred.

TABLE 4

| Sample time | | Purolite ™ C-160H | Amberlyst ™ A15 |
|---|---|---|---|
| (minutes) | Smopex ™ 101 | (comparison) | (comparison) |
| 0 | 1000 | 1000 | 1000 |
| 2 | 0 | 550 | 430 |
| 4 | 0 | 485 | 350 |
| 6 | 0 | 380 | 270 |
| 8 | 0 | 235 | 145 |
| 10 | 0 | 130 | 65 |
| 12 | 0 | 50 | 45 |
| 14 | 0 | 10 | 10 |
| 16 | 0 | 0 | 0 |
| 18 | 0 | 0 | 0 |

### EXAMPLE 8

The method of Examples 1-4 was repeated with a range of basic and non-basic organic nitrogen compounds at 1000 ppm in n-heptane at a flowrate of 10 hr⁻¹ under ambient temperature conditions unless otherwise stated.

a) Pyridine.

TABLE 5

| Time on line | ppm pyridine in |
|---|---|
| (hours) | exit |
| 1 | ND |
| 3 | ND |
| 5 | ND |
| 5.5 | ND |
| 6 | 104 |

Breakthrough was reached between 5.5 and 6 hours of run time. The pyridine broke through with a sharp profile.

b) Pyrrole

TABLE 6

| Time on line | ppm pyrrole in |
|---|---|
| (hours) | exit |
| 1 | 507 |

Although the pyrrole had broken through the Smopex 101 bed after 1 hour, the exit level of 507 ppm is only 50% of the inlet level of 1000 ppm; therefore, the Smopex 101 would seem to be removing some of the non-basic pyrrole.

c) Indole

This test was performed at a reduced LHSV of 2 h⁻¹.

TABLE 7

| Time on line | ppm indole in |
|---|---|
| (hours) | exit |
| 1 | 334 |
| 2 | 604 |

Although the indole had broken through the 100 ppm barrier after 1 hour, the exit levels of indole remained lower than the inlet for the remainder of the test run, indicating that an increased contact time could increase the ability of Smopex 101 to remove non-basic organo-nitrogen compounds.

d) 2-methylpyridine

TABLE 8

| | ppm 2- |
|---|---|
| Time on line | methylpyridine |
| (hours) | in exit |
| 1 | ND |
| 3 | ND |
| 4 | 21 |
| 4.5 | 373 |

Breakthrough was observed between 4 and 4.5 hours.

e) 2,6-dimethylpyridine

TABLE 9

| | ppm 2,6- |
|---|---|
| Time on line | dimethylpyridine |
| (hours) | in exit |
| 1 | ND |
| 3 | ND |
| 5 | ND |

SHUTDOWN OVER
3 NIGHTS

| | |
|---|---|
| 6 | 44 |
| 6.5 | 161 |
| 7 | 382 |

f) quinoline

TABLE 10

| Time on line | ppm quinoline |
|---|---|
| (hours) | in exit |
| 1 | ND |
| 3 | ND |
| 5 | ND |

SHUTDOWN OVERNIGHT

| | |
|---|---|
| 7 | ND |
| 8 | ND |
| 9 | 43 |
| 9.5 | 122 |
| 10 | 249 |

Breakthrough was reached between 9 and 9.5 hours of run time.

g) 2-methyiquinoline

TABLE 11

| | ppm 2- |
|---|---|
| Time on line | methylquinoline |
| (hours) | in exit |
| 1 | ND |
| 3 | ND |
| 4 | 4 |
| 5 | 34 |
| 6 | 65 |

SHUTDOWN OVERNIGHT

| | |
|---|---|
| 7 | 107 |

Breakthrough was reached between 6 and 7 hours of run time.

h) 8-methyiquinoline

TABLE 12

| | ppm 8- |
|---|---|
| Time on line | methylquinoline |
| (hours) | in exit |
| 1 | ND |
| 3 | ND |
| 4 | 102 |
| 5 | 158 |

Breakthrough was reached after 4 hours of run time.

i) 2,7-dimethyiquinoline

TABLE 13

| | ppm 2,7- |
|---|---|
| Time on line | dimethylquinoline |
| (hours) | in exit |
| 1 | ND |
| 2 | 44 |
| 2.5 | 69 |
| 3 | 106 |

Breakthrough was reached after 3 hours of run time.

j) acridine

TABLE 14

| Time on line | ppm acridine in |
|---|---|
| (hours) | exit |
| 1 | ND |
| 3 | ND |
| 5 | ND |
| 6 | ND |

SHUTDOWN OVER
3 NIGHTS

| | |
|---|---|
| 7 | ND |
| 8 | 16 |
| 9 | 48 |
| 10 | 81 |

SHUTDOWN OVERNIGHT

| | |
|---|---|
| 11 | 265 |

Breakthrough was reached between 10 and 11 hours of run time.

Several trends can be observed. The non-basic species, pyrrole, broke through earliest, although some removal is still occurring. As the basic molecules increase in size, the breakthrough time increases. As a molecule becomes more substituted, it breaks through earlier than its parent molecule. This may be due to steric hindrance around the nitrogen atom effecting its interaction with the sulphonic acid functional groups of the polymer fibres.

### EXAMPLE 9

### Effect of Organo-Sulphur Contamination

A pyridine/thiophene/n-heptane solution was prepared containing 1000 ppm pyridine and about 1000 ppm thiophene and tested according to the method of Examples 1-4 except that the space velocity was reduced to 3.2 h⁻¹.

The results are given in table 15.

TABLE 15

| Time on line | ppm pyridine in | ppm thiophene in |
|---|---|---|
| (hours) | exit | exit |
| 1 | ND | 1071 |
| 3 | ND | 1051 |
| 5 | ND | 1065 |
| 6 | ND | 1059 |

SHUTDOWN OVER 3 NIGHTS

| | | |
|---|---|---|
| 7 | ND | 1053 |
| 8 | ND | 1077 |
| 9 | ND | 1079 |
| 10 | ND | 1070 |
| 11 | ND | 1082 |
| 12 | ND | 1080 |
| 13 | ND | 1065 |

SHUTDOWN OVERNIGHT

| | | |
|---|---|---|
| 14 | ND | 1082 |
| 15 | ND | 1073 |
| 16 | ND | 1086 |
| 17 | ND | 1084 |
| 18 | 91 | 1103 |
| 18.5 | 745 | 1050 |

Breakthrough was reached between 18 and 18.5 hours of run time. Although this test was performed under different conditions (LHSV=3.2 h−1), it shows Smopex 101 does not remove thiophene which therefore surprisingly does not compete for the functional groups. It also demonstrates that by increasing the contact time, the time taken to breakthrough increases.

The above experiment was repeated at a space velocity of 10 hr⁻¹.

TABLE 16

| Time on line | ppm pyridine in | ppm thiophene in |
|---|---|---|
| (hours) | exit | exit |
| 1 | ND | 1004 |
| 2 | ND | 1004 |
| 3 | ND | 1000 |
| 4 | ND | 1022 |
| 5 | 103 | 1022 |
| 5.5 | 598 | 1022 |

In comparison with pyridine in the feed alone (Example 1), which broke through at ca 5 hours, pyridine with thiophene in the feed reached breakthrough at roughly the same time, even though thiophene was not removed from the solution.

The above experiment was repeated using quinoline in place of pyridine.

TABLE 17

| Time on line | ppm quinoline in | ppm thiophene in |
|---|---|---|
| (hours) | exit | exit |
| 1 | ND | 1017 |
| 2 | ND | 1314 |
| 3 | ND | |
| 4 | ND | |
| 5 | ND | 1347 |
| 6 | 32 | 1334 |
| 7 | 75 | 1327 |

SHUTDOWN OVERNIGHT

| | | |
|---|---|---|
| 7.5 | 96 | 1295 |
| 8 | 121 | 1295 |

1.-15. (canceled)

16. A process for removing one or more nitrogen compounds from a fluid comprising:
contacting a fluid with a functionalised polymer fibre material having at least one functional group capable of reacting with one or more nitrogen compounds.

17. A process according to claim 16, wherein the one or more nitrogen compounds are basic nitrogen compounds.

18. A process according to claim 16, wherein the functionalised polymer fibre comprises a polymer selected from the group consisting of polyolefins, polyolefin-styrene copolymers, polyacrylates, fluorinated polyethylene, cellulose and viscose,

19. A process according to claim 16, wherein the at least one functional group is selected from the group consisting of carboxylic acid, sulphonic acid, acrylic acid, methacrylic acid, vinyl benzyl chloride, vinyl benzyl boronic acid, vinyl benzyl aldehyde and vinyl sulphonic acid.

20. A process according to claim 19, wherein the at least one functional group is at least one sulphonic acid group.

21. A process according to claim 16, wherein the functionalised polymer fibre has at least 1.0 mmol of the at least one functional group per gram.

22. A process according to claim 16, wherein the functionalised polymer fibre material is spun, woven, carded, needle-punched, felted, converted into a thread, rope, net, tow, woven or non-woven fabric.

23. A process according to claim 22, wherein the functionalised polymer fibre material is combined with inorganic fibres or non-functionalised polymer fibres.

24. A process according to claim 16, wherein the fluid comprises a hydrocarbon stream.

25. A process according to claim 24 wherein the fluid is selected from the group consisting of naphtha, middle distillate or atmospheric gas oil, vacuum gas oil, cycle oil or residuum or a hydrocarbon stream produced from such a feedstock; a crude oil stream or a synthetic crude stream; a condensate; and natural gas or gaseous refined paraffins or olefins.

26. A process according to claim 24, wherein the hydrocarbon stream is hydrotreated, before or after treatment with the functionalised polymer fibre.

27. A process according to claim 24, wherein the hydrocarbon stream is subjected to catalytic reforming, fluid catalytic cracking, or hydrocracking after treatment with the functionalised polymer fibre.

28. A process according to claim 16, wherein the fluid is selected from the group consisting of an alcohol, an ester, an ether, carbon dioxide, natural oil or fat, air and anaesthetic gas.

29. A process according to claim 16, wherein a stream of the fluid flows through a bed of the functionalised polymer fibre.

30. A process according to claim 29 wherein a space velocity of the fluid through the bed is 15 hr⁻¹.

31. A process according to claim 16, wherein the functionalised polymer fibre further comprises a metal or a metal ion.

32. A process according to claim 31, wherein the metal or the metal ion is selected from the group consisting of copper, iron, manganese, cobalt, and nickel.

33. A process according to claim 25, wherein the fluid is the condensate selected from the group consisting of a natural gas liquid and a liquefied petroleum gas.
